(19) United States
(12) Patent Application Publication
(10) Pub. No.: US 2007/0278889 A1
(43) Pub. Date: Dec. 6, 2007

(54) Rotating Machine and Gas Turbine System

(76) Inventors: Manabu Sasaki, Hitachi (JP); Masakazu Shinden, Hitachi (JP); Yasunori Ohtsuki, Hitachi (JP); Kazumasa Ide, Hitachiota (JP); Mamoru Kimura, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/753,088

(22) Filed: May 24, 2007

(30) Foreign Application Priority Data
May 31, 2006 (JP) 2006-150999

(51) Int. Cl. H02K 1/04; H02K 21/12; H02K 1/00; H02K 23/02

(52) U.S. Cl. 310/184; 310/180; 310/43; 310/216; 310/156.28

(57) ABSTRACT

A rotating machine including a stator iron core having a plurality of slots installed in the direction of a rotary shaft, a plurality of armature windings alternately inserted and wound round an outer layer of one of the slots and an inner layer of another slot, and a rotor having a plurality of magnetic poles for rotating inside the stator iron core and each of the armature windings is composed of a single covered conductor wound and has a leading line on the one-end side of the stator iron core.

### CLAIM OF PRIORITY

The present application claims priority from Japanese application serial no. 2006-150999, filed on May 31, 2006, the content of which is hereby incorporated by reference into this application.

### FIELD OF THE INVENTION

The present invention relates to a rotating machine using an armature winding inserted alternately into an outer layer and an inner layer of a slot and a gas turbine system.

### BACKGROUND OF THE INVENTION

Generally, in a rotating machine, realization of high efficiency of a generator is one of the most important problems. To realize high efficiency of the generator, it may be considered to reduce the dimensions of a coil end, thereby reduce a copper loss, and reduce an electrical loss (an eddy current loss) generated in a rotor. Here, the coil end is referred to as a part of a covered copper wire wound round one slot and then another slot and a connection part of covered copper wires entering the slots.

As an art for reducing the length of the coil end in the direction of the rotary shaft, for example, as indicated in Japanese Patent Laid-open No. 2004-282858 (Patent Document 1), an art for bending the covered copper wire of the coil end respectively inside and outside in the radial direction of a stator is proposed. According to this, one coil end has no connection point, so that the length of the coil end in the direction of the rotary shaft can be shortened.

Further, generally, in a double-layer winding synchronous machine (synchronous generator) used for a turbine generator, to reduce the eddy current loss (electrical loss) generated in the rotor, a short pitch winding is used and the short pitch winding is disclosed, for example, in Japanese Patent Laid-open No. 2000-350396 (Patent Document 2). Here, the short pitch winding is referred to as a winding method for making the coil pitch smaller than the pole pitch and particularly in a three-phase machine, the ratio of the coil pitch to the pole pitch (short pitch degree β) is taken as 5/6, thus the fifth and seventh space higher harmonics are reduced.

### SUMMARY OF THE INVENTION

However, the art described in Patent Document 1 is an art for forming a concentric winding for bending the coil at the coil end inside and outside in the radius direction of the stator, thereby cannot reduce an electrical loss (eddy current loss) generated in the rotor using the short pitch winding.

Further, in a general double-layer winding synchronous machine including Patent Document 2, the coils inserted in each slot are mutually brazed and connected at the coil ends, so that a problem arises that the length of each coil end in the direction of the rotary shaft is increased. Particularly, a generator (rotating machine) used for a micro-gas turbine is preferably rotated at super-speed of several ten thousands rpm to generate electricity at high frequency and particularly, the eddy current loss comes into a problem. Further, when the length of each coil end in the direction of the rotary shaft is long, a problem arises that the vibration increases.

Therefore, the present invention is intended to provide a rotating machine capable of reducing the eddy current loss generated in the rotor and reducing the copper loss of the armature winding.

To solve the problems aforementioned, the rotating machine of the present invention is a rotating machine including a stator iron core having a plurality of slots installed in the direction of the rotary shaft, a plurality of armature windings alternately inserted and wound round the outer layer of one slot and the inner layer of another slot, and a rotor having a plurality of magnetic poles for rotating inside the stator iron core and each of the armature windings is composed of a single covered conductor wound and has a leading line on the one-end side of the stator iron core. Here, the outer layer is referred to as an outside area in the radial direction and the inner layer is referred to as an inside area in the radial direction.

According to this, a leading line is installed on the one-end side using a single covered conductor, so that no leading line is installed on the other end side. Therefore, the coil end on the other end side is shortened, thus the copper loss is reduced. Further, each armature winding is inserted alternately into the outer layer of one slot and the inner layer of another slot, so that it will not become a concentric winding, thus a short pitch winding in which the coil pitch is smaller than the magnetic pole pitch can be carried out. The short pitch winding is carried out, thus the space higher harmonics are reduced and the eddy current loss is reduced.

Further, each armature winding can be formed by inserting a covered conductor from the one-end side of the stator iron core into one of the inner layer and outer layer, inserting the covered conductor pulled out from this one layer from the other end side of the stator iron core into another layer different from the aforementioned one layer of the aforementioned another slot, and inserting the covered conductor pulled out from the other layer from the aforementioned one-end side into the layer equivalent to the aforementioned one layer of the slot neighboring the aforementioned one slot.

According to the present invention, a rotating machine capable of reducing the copper loss of the armature winding can be provided. Furthermore, by the short pitch winding, the eddy current loss can be reduced.

### BRIEF DESCRIPTION OF THE DRAWINGS

FIG. 1 is a cross sectional view showing the outline of the rotating machine of the first embodiment of the present invention;

FIG. 2 is a wiring diagram of the coil end of the rotating machine on the non-connection side of the first embodiment of the present invention;

FIG. 3 is a connection diagram of the coil of the rotating machine of the first embodiment of the present invention;

FIG. 4 is an illustration showing the wire assembling condition of the coil of the rotating machine of the first embodiment of the present invention;

FIG. 5 is an illustration showing the final shape after assembly of the coil of the rotating machine of the first embodiment of the present invention;

FIG. 6 is a schematic vertical side view showing the outline of the rotating machine of the second embodiment of the present invention;

FIG. 7 is a schematic vertical side view showing the outline of the rotating machine of the third embodiment of the present invention;

FIG. 8 is an enlarged view of the slot portion of the rotating machine of the fourth embodiment of the present invention;

FIG. 9 is a schematic vertical side view showing the outline of the rotating machine of the fifth embodiment of the present invention;

FIG. 10 is an external view and a cross sectional view of the ritz wire; and

FIG. 11 is a block diagram of a gas turbine system.

### DESCRIPTION OF THE PREFERRED EMBODIMENTS

### First Embodiment

The rotating machine of an embodiment of the present invention is a high-speed generator used for a micro-gas turbine, which is a permanent magnet type rotating machine composed of a permanent magnet incorporated in a rotor.

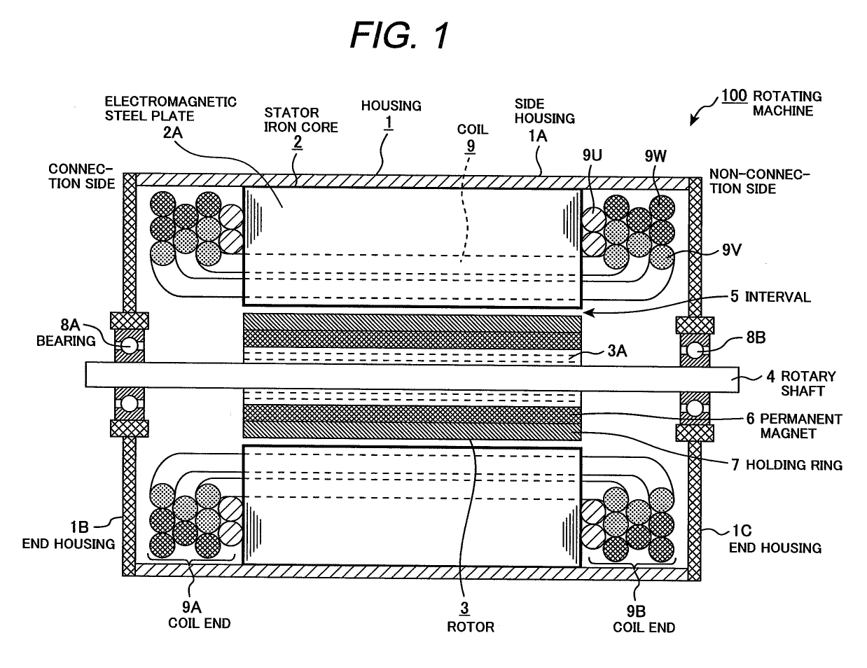

In the cross sectional view shown in FIG. 1, a rotating machine 100 includes a housing 1 composed of a substantially cylindrical side housing 1A and almost circular end housings 1B and 1C which are mutually connected by bolts (not drawn), bearings 8A and 8B fixed to the housing 1 for fixing rotatably a rotary shaft 4, a rotor 3 having two poles of the north pole and south pole which is fixed to the rotary shaft 4, and a stator iron core 2 positioned on the outer periphery of the rotor 3 and fixed to the housing 1 with an interval 5 kept.

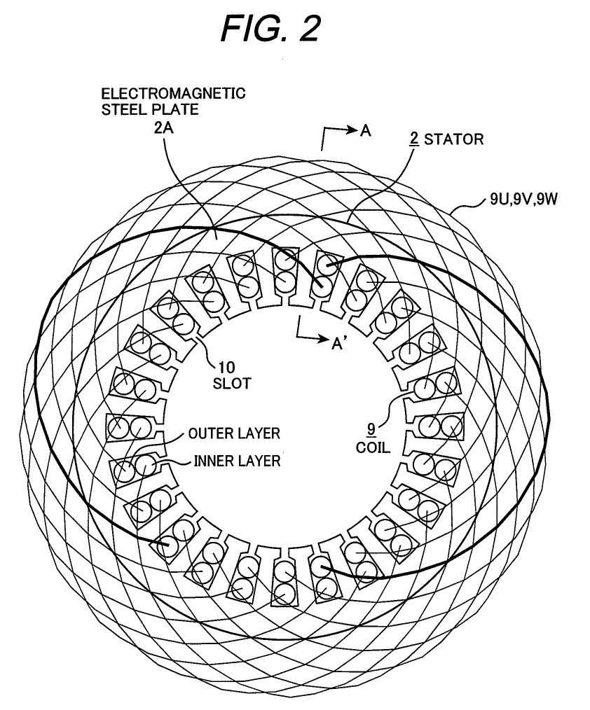

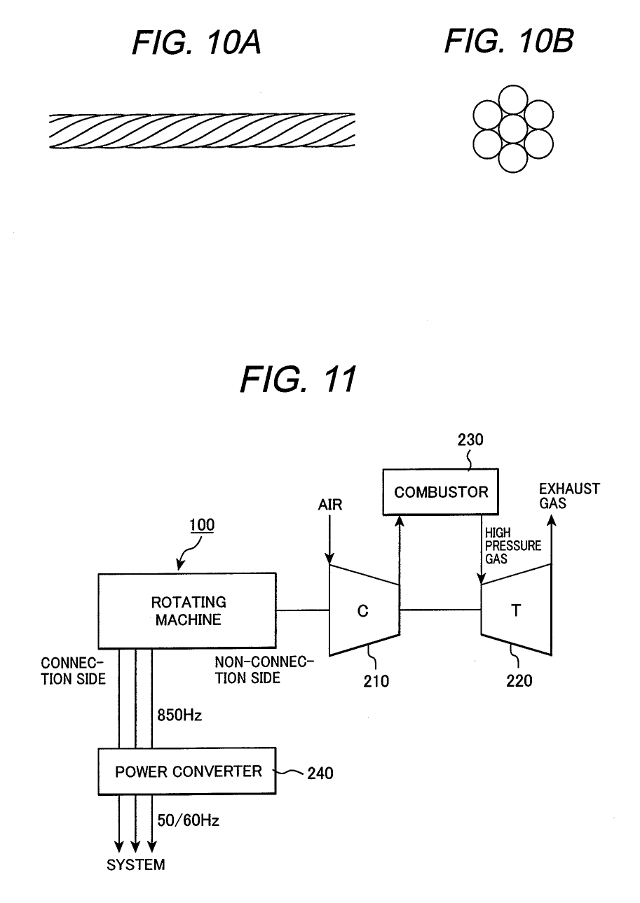

The stator iron core 2 is composed of thin electromagnetic steel plates 2A in a hollow circular shape (a ring shape) which are laminated and are formed in a cylindrical shape and has a plurality of slots 10 (refer to FIG. 2) which are slots for forming the coils 9 which are armature windings. The coils 9 are formed by a bundle of copper wires covered with an insulating coating and are wound round the slots 10. The coils 9 (9U, 9V, 9W) are wound so as to be folded back outside the slot in the neighborhood of the end face of the stator iron core 2 and be inserted into another slot (not drawn). Further, the coils 9 use a ritz wire (refer to the external view and cross sectional view shown in FIG. 10) which is a bundle of a covered conductor, thus an increase in the AC resistance due to the skin effect and an increase in the eddy current loss of the coil conductors due to the leakage flux are suppressed, thus a highly efficient rotating machine can be obtained.

The neighborhood of the end face of the stator iron core 2 where the coils 9 are folded back are referred to as coil ends 9A and 9B. The end portion having the connection end of a neutral line and a terminal line which are not drawn is referred to as a connection side (the left side of FIG. 1) and the end portion having no connection end is referred to as a non-connection side (the right side of FIG. 1). The rotor 3 includes a rotor iron core 3A, a permanent magnet 6 arranged on the outer periphery of the rotor iron core 3A, and a holding ring 7 installed on the outer periphery of the permanent magnet 6 to prevent the permanent magnet 6 from scattering. Further, the holding ring 7 uses a non-magnetic metal and can cool efficiently an eddy current loss generated on the surface of the holding ring of the rotor 3 due to satisfactory thermal conduction of the metal. Further, the stator is composed of the stator iron core 2 including the coils 9 and between the holding ring 7 and the inner surface of the stator, the interval 5 is formed.

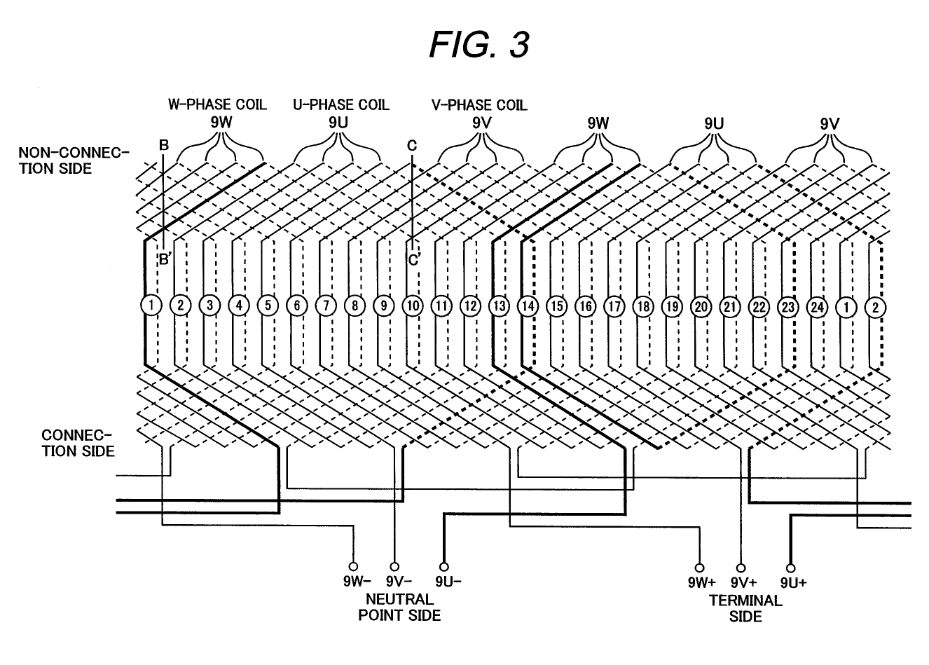

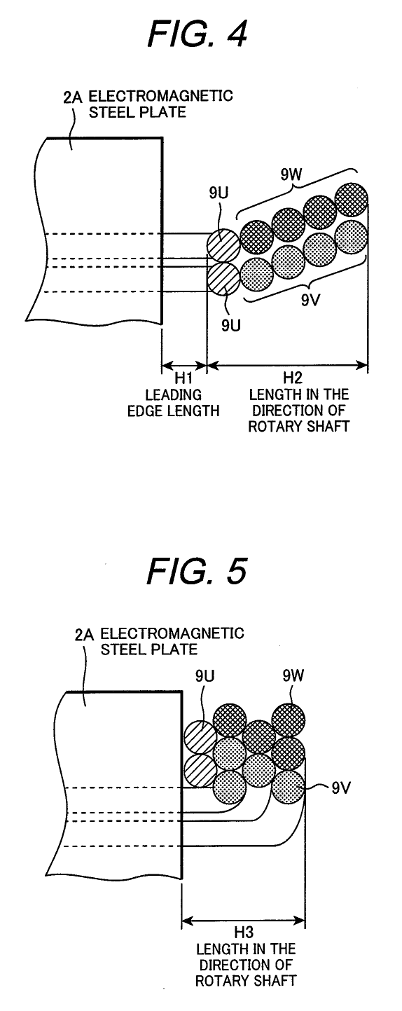

FIG. 2 is a connection diagram of the coils 9 viewed from the non-connection side of the stator iron core 2 and FIG. 3 is a connection diagram of the coils 9. In FIG. 2, the stator iron core 2 has 24 slots 10 in the radial direction and 24 tees on the inner surfaces are close to the outer surface of the rotor 3 (refer to FIG. 1). Further, each slot 10 is a space into which two covered conductors are inserted and on the inner layer which is an inside area of the space in the radial direction and the outer layer which is an outside area in the radial direction, side part of each coil 9 is arranged. Further, the coils 9 (9U, 9V, 9W) are short-pitch wound coils of a short pitch degree β of 5/6 having three phases, two poles, and 24 slots. Here, the short pitch degree β is a ratio of the coil pitch to the pole pitch, and in a three-phase machine, β is 5/6, and the fifth and seventh space higher harmonics are reduced. Further, the short pitch winding is a winding method for making the coil pitch smaller than the pole pitch and the space higher harmonics are reduced. For simplicity of explanation, the two windings indicated by the thick lines are pulled out from or inserted into the same slot, though they are inserted into the slots on both sides different from the opposite slot. Further, in a case of two poles, when the winding of each of the coils 9 is separated electrically 180°, it is full pitch winding. Further, the view line A-A′ shown in FIG. 2 indicates the direction of sight line of the sections shown in FIGS. 4 and 5 which will be described later.

In the connection diagram shown in FIG. 3, a covered conductor inserted into the inner layer of each slot of the 1st to 24th slots is indicated by a solid line, and a covered conductor inserted into the outer layer of each slot is indicated by a dashed line, and in the neighborhood of the covered conductor of the 24th slot, the covered conductors of the 1st and 2nd slots are indicated as superimposed. Further, on the connection side, the terminals of the covered conductors are pulled out, and the neutral point sides 9W−, 9V−, and 9U− are pulled out as a neutral point connection end, and the terminal sides 9W+, 9V+, and 9U+ are pulled out outside the rotating machine 100 as a power source connection end. The terminals of the neutral point sides 9W−, 9V−, and 9U− and the terminal sides 9W+, 9V+, and 9U+ are referred to as leading lines. Further, the neutral point sides 9W−, 9V−, and 9U− are specially connected to each other as a neutral line.

As an example, the covered conductor (a part thereof) of the neutral point side 9U− is indicated by a thick line and it passes through the inner layer of the 13th slot, is pulled out by the inner layer, is folded back on the non-connection side, and is inserted into the outer layer of the 23rd slot. The covered conductor pulled out from the outer layer of the 23rd slot is folded back on the connection side and is inserted into the inner layer of the 14th slot neighboring the 13th slot. The inserted covered conductor is folded back 4 times on the non-connection side and is inserted into the outer layer of the 2nd slot.

Namely, the coils 9 are formed by inserting a covered conductor from the one-end side of the stator iron core into one of the inner layer and outer layer, inserting the covered conductor pulled out from this one layer from the other end side of the stator iron core 2 into another layer different from the aforementioned one layer of the aforementioned another slot 10, and inserting the covered conductor pulled out from the other layer from the aforementioned one-end side into the layer equivalent to the aforementioned one layer of the slot 10 neighboring the aforementioned one slot 10.

Furthermore, the covered conductor inserted into the outer layer of the 2nd slot on the non-connection side is inserted into the outer layer of the 14th slot on the connection side (at this time, the covered conductor moves from the right end of the drawing to the left end) and the covered conductor passing through the outer layer of the 14th slot is inserted into the inner layer of the 4th slot on the non-connection side. Similarly, the covered conductor folded back 4 times on the non-connection side and inserted into the inner layer of the 1st slot on the non-connection side becomes the 9U+ connection terminal on the connection side (at this time, the covered conductor moves from the left end of the drawing to the right end). As mentioned above, the covered conductor in each phase is a single covered conductor.

In an ordinary synchronous machine, a coil is inserted every 10 slots and the coils are brazed and connected at the coil ends 9A and 9B. However, in the rotating machine 100 of this embodiment, as mentioned above, to shorten the length of the coil ends 9A and 9B in the direction of the rotary shaft, the coil in each phase is wire-assembled continuously by one covered conductor. Further, the two 13th and 14th slots are superimposed to realize short pitch winding.

Further, assuming the number of slots of the rotating machine 100 as Ns and the number of poles as P, the section of the coil ends in the direction of the rotary shaft on the non-connection side is composed of (Ns/P·5/6+1) covered conductors or less. Namely, it indicates that the short pitch degree of short pitch winding is 5/6 or less. In FIG. 3, the number of slots is 24, and the number of poles is 2, and the number of covered conductors at this time is 11. In the section C-C′ shown in FIG. 3, there are 11 covered conductors including the solid lines and dashed lines and in another section, for example, the section B-B′, there are 10 covered conductors. Therefore, the space higher harmonics are reduced, so that the electrical loss (eddy current loss) generated in the rotor 3 can be reduced.

Further, when the wires are all assembled in one phase in the wire assembling order of the U-phase coils 9U, the V-phase coils 9V, and the W-phase coils 9W and then the next phase is wire-assembled, if two coils are inserted into the same slot, the coils interfere mutually at the leading edge portions of the coils at the coil ends and it is very difficult to wire-assemble all the coils (U-phase coils 9U, V-phase coils 9V, W-phase coils 9W). Therefore, the wire assembly is carried out in the sequence indicated below.

(1) Terminal side U-phase coils 9U+

(2) Terminal side V-phase coils 9V+

(3) Terminal side W-phase coils 9W+

(4) Neutral point side U-phase coils 9U−

(5) Neutral point side V-phase coils 9V−

(6) Neutral point side W-phase coils 9W−

However, 9U+ indicates from the crossover track of the U-phase coils to the power source connection end and 9U− indicates from the crossover track of the U-phase coils to the neutral line connection end. The same may be said with the V phase and W phase. Here, the crossover track indicates a folding-back line on the non-connection side or connection side.

In short, in the case of two poles, it is preferable to wind a half of covered conductors in each phase, thereby form terminal-side 9U+, 9V+, and 9W+ coils and wind the other half in each phase, thereby form neutral point side 9U−, 9V−, and 9W− coils. Further, it is preferable to wind the neutral point side 9U−, 9V−, and 9W− coils in the winding sequence of the terminal-side 9U+, 9V+, and 9W+ coils.

The cross sectional view in FIG. 4 shows the coil position before coil reform after wire assembly and FIG. 5 shows the coil position after coil reform after wire assembly. FIGS. 4 and 5 show the section on the view line A-A′ shown in FIG. 2 and the slot position on the section on the view line A-A′ is equivalent to the position B-B′ shown in FIG. 3. In this section, the U-phase coils 9U have two coil sections, and the V-phase coils 9V have four coil sections, and the W-phase coils 9W have four coil sections, 10 coils sections in total. When wire-assembling first, as shown in FIG. 4, the leading edge length H1 of the coils is made rather longer and the length H2 of the coil ends in the direction of the rotary shaft is set to a length equivalent to five coils. Thereafter, the coil ends are reformed, thus as shown in FIG. 5, the length H3 of the coil section in the direction of the rotary shaft is formed shorter.

As explained above, according to this embodiment, only on the connection side, the leading lines of the coils 9 are provided, and no leading lines are provided on the non-connection side, so that the coil end 9B is shortened and the copper loss is reduced. Further, the short pitch winding can be executed, so that the space higher harmonics are reduced and the eddy current loss (electrical loss) generated in the rotor 3 is reduced. Therefore, a highly efficient rotating machine 100 can be obtained and the unstable vibration and low frequency vibration due to thermal bending of the rotor can be reduced. Further, a half of the covered conductors is wound in each phase and the other half is wound in each phase, thus wire assembly can be made easy.

### Second Embodiment

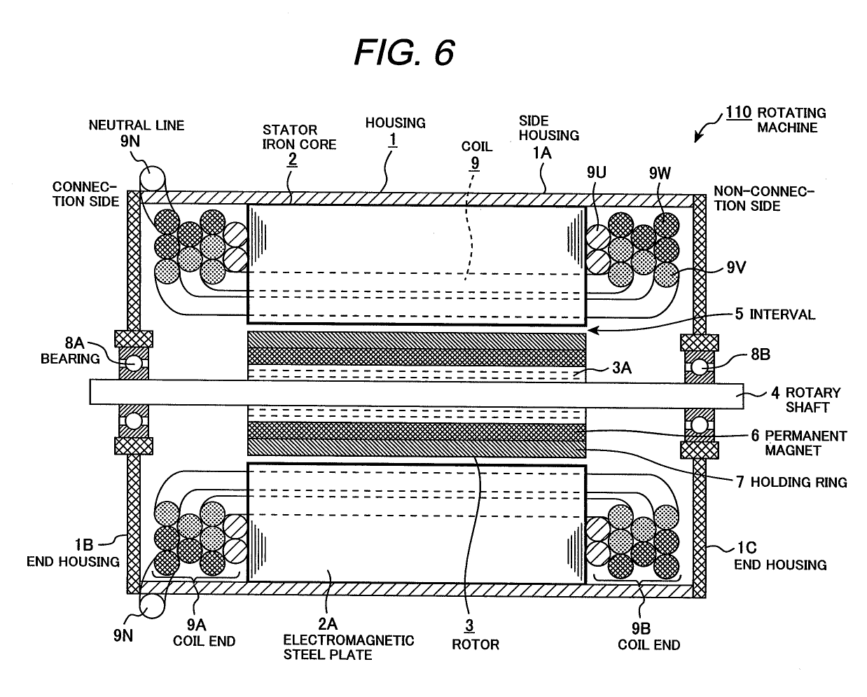

In the first embodiment, no connection end is provided on the neutral point side, though in this embodiment, a connection end is provided, thus a neutral line can be provided. The rotating machine of the second embodiment will be explained by referring to FIG. 6. It is only one difference that a neutral line is provided and the other points coincide with those shown in FIGS. 1 to 5, so that to the same parts, the same numerals are assigned. In a rotating machine 110 of this embodiment, the connection end of a neutral line 9N is installed outside the housing 1, so that the length of the coil end 9A in the direction of the rotary shaft on the connection side can be made smaller. Further, when the neutral line 9N passes through the outside (outer periphery) of the housing 1, the length in the direction of the rotary shaft on the connection side can be made almost equal to the length on the non-connection side.

### Third Embodiment

In the second embodiment, the neutral line 9N passes through the outside of the housing 1, though in this embodiment, the neutral line 9N can be installed inside the housing 1.

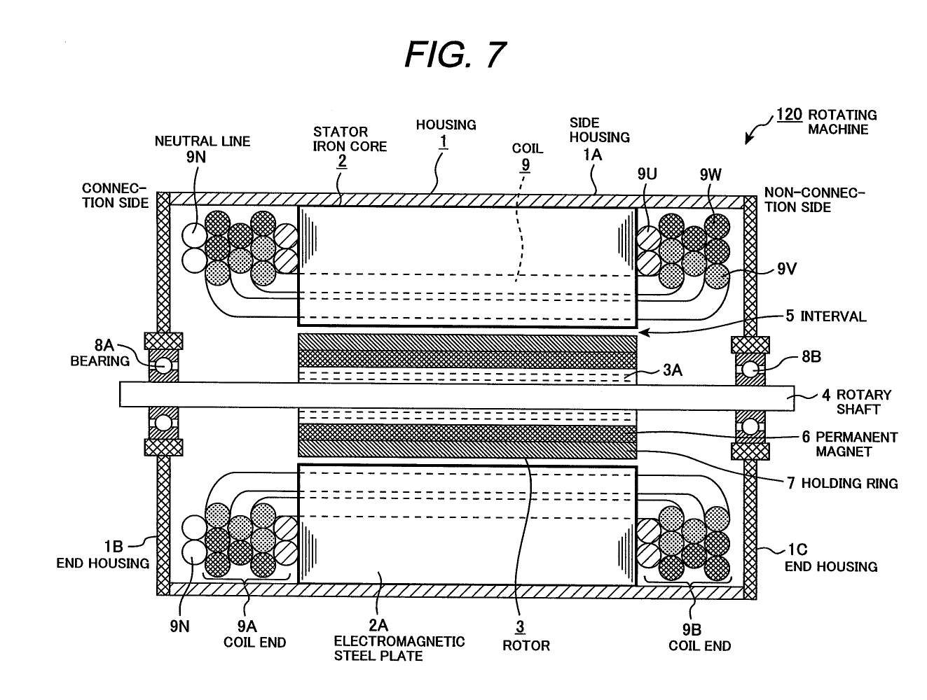

The rotating machine of the third embodiment will be explained by referring to FIG. 7. In a rotating machine 120 of this embodiment, the neutral line 9N is installed inside the housing 1. Therefore, the length of the coil end 9A in the direction of the rotary shaft on the connection side is longer than that of the rotating machine 110 of the second embodiment, though there is no need to make a hole in the housing 1, so that the man-hour can be reduced. Further, the airtightness in the rotating machine 120 can be improved, so that the cooling property is improved.

### Fourth Embodiment

Next, the rotating machine of the fourth embodiment of the present invention will be explained.

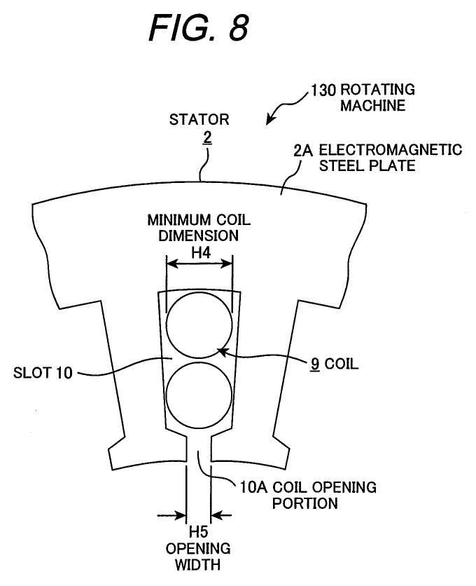

To the same parts as those shown in FIGS. 1 to 5, the same numerals are assigned and another detailed explanation will be omitted. In the stator iron core 2 shown in FIG. 8 which is used for a rotating machine 130, a minimum dimension H4 of the coils 9 is formed so as to be larger than an opening width H5 of a slot opening 10A. By doing this, a “coil wedge” for preventing the covered conductor of the coils 9 from coming off the slot opening 10A is not required. Therefore, the man-hour and cost can be reduced.

### Fifth Embodiment

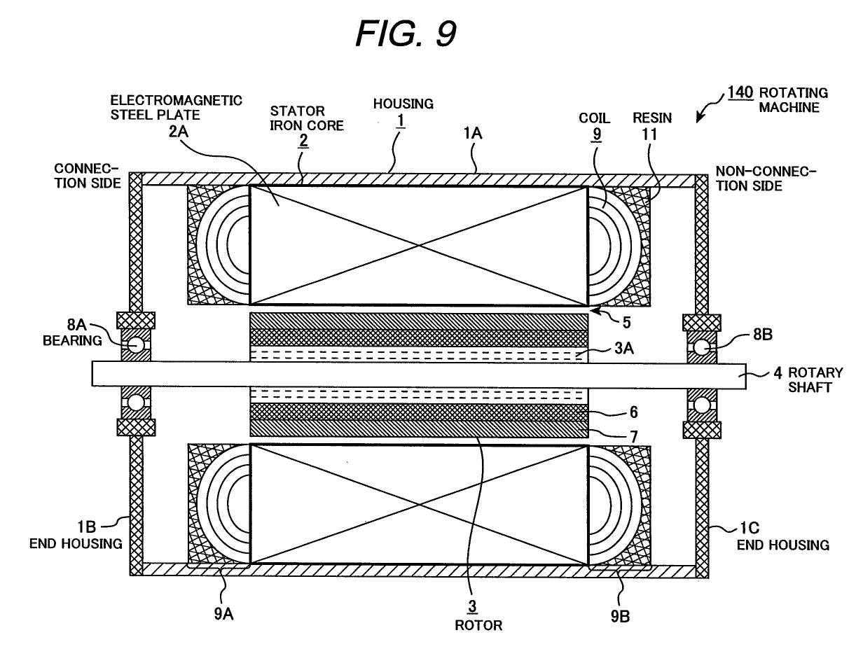

Next, the rotating machine of the fifth embodiment of the present invention will be explained by referring to FIG. 9. The same parts as those shown in FIGS. 1 to 5 are indicated by the same numerals and another detailed explanation will be omitted. In FIG. 9, in a rotating machine 140 of this embodiment, a resin 11 is arranged around the coil ends 9A and 9B and covers the coils 9. The resin 11 is mixed with thermal conductive fillers such as metallic power and has a cooling function. Therefore, the coil ends 9A and 9B can be cooled efficiently. Particularly, in a rare-earth permanent magnet, at high temperature, the magnetic characteristic gets worse, and the generator efficiency is lowered, so that it is useful to cool the coils 9 which are a heat generation source.

(Gas Turbine System)

Next, a gas turbine system using the rotating machine 100 (110, 120, 130, 140) of the embodiments of the present invention will be explained. The gas turbine system is a micro-gas turbine system and the rotating machine 100, a compressor 210, and a turbine 220 are connected directly and these units rotate at a high speed. In the stationary state, air compressed by the compressor 210 and fuel are supplied to a combustor 230, thereby are burned, and high-pressure gas is poured into the turbine 22, and exhaust gas is discharged from the turbine 220 into the air. At this time, the turbine is rotated by the process of expansion of high pressure and high temperature gas and the compressor 210 and rotating machine 100 (110, 120, 130, 140) rotate at high speed, for example, at about 51000 rpm. Even if they rotate at high speed, the length of the coil end 9B of the rotating machine 100 in the direction of the rotary shaft is short, so that stable running with little shaft vibration can be realized.

Further, three-phase AC power at about 850 Hz outputted from the connection side of the rotor of the rotating machine 100 is converted to commercial power at 50/60 Hz by a power converter 240 and is outputted to the power system. Power can be generated at a high frequency such as 850 Hz, so that miniaturization and high output are realized. Here, the coil end having a neutral point connection end and a power source connection end is located on the opposite direct connection side. Therefore, when directly connecting with the compressor 210 and turbine 220, the assembly is made easy.

(Modification)

The present invention is not limited to the embodiments aforementioned and for example, the following various modifications are available.

(1) In the embodiments aforementioned, the neutral line is installed and Y-connected, though the power source connection ends can be connected mutually and Δ-connected.

(2) In the embodiments aforementioned, the coils are composed of 24 slots and 2 poles, though they may be generalized so as to be composed of even N slots and P poles. In this case, the coil 9 of an armature winding is inserted into the slot at the position closer than the N/Pth slot from the pulled-out slot 10 and is short-pitch wound.

(3) The rotating machine of the embodiments aforementioned is structured as a three-phase AC generator, though it may be structured as a three-phase AC motor.

What is claimed is:

1. A rotating machine comprising:
a stator iron core having a plurality of slots installed in a direction of a rotary shaft,
a plurality of armature windings alternately inserted and wound round an outer layer of one of said slots and an inner layer of another slot, and
a rotor having a plurality of magnetic poles for rotating inside said stator iron core, wherein:
each of said armature windings is formed by inserting a covered conductor from a one-end side of said stator iron core into one of said inner layer and said outer layer, inserting said covered conductor pulled out from said one layer from another end side of said stator iron core into another layer different from said one layer of said another slot, and inserting said covered conductor pulled out from said one-end side of said other layer from said one-end side into a layer equivalent to said one layer of a slot neighboring said one slot and
a leading line of each of said armature windings is installed on said one-end side.

2. The rotating machine according to claim 1, wherein:
the number of said slots is an even number of N,
the number of poles of said rotor is P, and
said another slot is a slot at a position closer than an N/Pth slot from said one slot.

3. The rotating machine according to claim 1, wherein:
said plurality of armature windings are three-phase connected coils and
said leading line is used as a Y-connected neutral point connection end and a power source connection end or used as a Δ-connected power source connection end.

4. A rotating machine comprising:
a stator iron core having a plurality of slots installed in a direction of a rotary shaft,
a plurality of armature windings alternately inserted and wound round an outer layer of one of said slots and an inner layer of another slot, and
a rotor having a plurality of magnetic poles for rotating inside said stator iron core, wherein:
each of said armature windings is composed of a single covered conductor wound and has a leading line installed on a one-end side of said stator iron core.

5. The rotating machine according to claim 4, wherein:
the number of said slots is an even number of N,
the number of poles of said rotor is P, and
said armature windings are short-pitch wound so as to insert said covered conductor pulled out from said one slot into another slot inside said N/Pth slot.

6. The rotating machine according to claim 5, wherein
in said another slot, on another end side of said stator iron core, the number of said covered conductors on an optional section including a rotational central axis of said rotor is “N/P·5/6+1” or less.

7. The rotating machine according to claim 4, wherein:
said plurality of armature windings are three-phase connected coils and
said leading line is used as a Y-connected neutral point connection end and a power source connection end or used as a Δ-connected power source connection end.

8. The rotating machine according to claim 7, further comprising a housing for storing said stator iron core, said armature windings, and said rotor, wherein:
said neutral point connection end is installed outside said housing.

9. The rotating machine according to claim 7, further comprising a housing for storing said stator iron core, said armature windings, and said rotor, wherein:
said neutral point connection end is installed inside said housing.

10. The rotating machine according to claim 4, wherein:
said rotor includes a magnet and a holding ring installed on an outer periphery of said magnet for protecting said magnet and
said holding ring is composed of a non-magnetic metal.

11. The rotating machine according to claim 4, wherein in said slots, an opening width of an opening is smaller than an outside diameter of said covered conductors bundled.

12. The rotating machine according to claim 4, wherein on a one-end side and an another-end side of said stator iron core, a cooling resin is provided.

13. The rotating machine according to claim 4, wherein said covered conductors are a ritz wire.

14. The gas turbine system comprising:
a rotating machine stated in claim 1, and
a compressor and a turbine directly connected to said rotor on an another-end side different from said one-end side.

15. The gas turbine system comprising:
a rotating machine stated in claim 4, and
a compressor and a turbine directly connected to said rotor on an another-end side different from said one-end side.
